(19) United States
(12) Patent Application Publication
(10) Pub. No.: US 2015/0354538 A1
(43) Pub. Date: Dec. 10, 2015

(54) ROTATING MAGNETIC WIND GENERATOR

(71) Applicant: Larry Lindon McReynolds, Cockeysville, MD (US)

(72) Inventor: Larry Lindon McReynolds, Cockeysville, MD (US)

(21) Appl. No.: 14/543,309

(22) Filed: Nov. 17, 2014

Related U.S. Application Data
(60) Provisional application No. 62/009,987, filed on Jun. 10, 2014.

(51) Int. Cl. F03D 9/00; F03D 3/04; F03D 11/00; F03D 3/00

(52) U.S. Cl. CPC F03D 9/002; F03D 3/005; F03D 3/04; F03D 11/0008

(57) ABSTRACT

A wind electrical generator is provided. The wind electrical generator includes a housing having an upper portion and a lower portion. A center shaft is rotatably mounted within the housing and runs from the lower portion to the upper portion. A plurality of wind blades extend radially from the center shaft. The housing directs wind towards the plurality of wind blades, such as by including an angled frame. At least one magnetic rotational arm extends radially from the center shaft at the lower portion. A plurality of magnets extend downward from that magnetic rotational arm. The present invention further includes an array of pick-up coils forming channels in between. The plurality of wind blades is operable to receive wind to rotate the center shaft and thereby rotate the at least one magnetic rotational arm so that the plurality of magnets rotate within the at least one channel of the array and thereby generate electricity.

### CROSS-REFERENCE TO RELATED APPLICATION

This application claims the benefit of priority of U.S. provisional application No. 62/009,987, filed Jun. 10, 2014, the contents of which are herein incorporated by reference.

### BACKGROUND OF THE INVENTION

The present invention relates to generators and, more particularly, to a rotating magnetic wind generator.

A wind turbine is a device that converts kinetic energy from the wind into electrical power. A wind turbine used for charging batteries may be referred to as a wind charger. The result of over a millennium of windmill development and modern engineering, today's wind turbines are manufactured in a wide range of vertical and horizontal axis types. The smallest turbines are used for applications such as battery charging for auxiliary power for boats or caravans or to power traffic warning signs. Slightly larger turbines can be used for making small contributions to a domestic power supply while selling unused power back to the utility supplier via the electrical grid. Arrays of large turbines, known as wind farms, are becoming an increasingly important source of renewable energy and are used by many countries as part of a strategy to reduce their reliance on fossil fuels.

Current wind generators have placement restrictions due to the rotating airplane blade assembly design and usage restrictions caused by that type of rotation. Many smaller generators using different forms of rotation are too small to handle any electrical load requirement for a building or home and all utilize off-the-shelf generators reducing their usefulness. Further, wind generators lack the ability to operate in high winds or in really fowl weather.

As can be seen, there is a need for an improved wind generator for home, high-rise buildings and business use.

### SUMMARY OF THE INVENTION

In one aspect of the present invention, a wind electrical generator comprises: a housing comprising an upper portion and a lower portion; a center shaft rotatably mounted within the housing and running from the lower portion to the upper portion; a plurality of wind blades extending radially from the center shaft at the upper portion, wherein the housing directs wind towards the plurality of wind blades; at least one magnetic rotational arm extending radially from the center shaft at the lower portion; a plurality of magnets extending downward from the at least one magnetic rotational arm; an array of a plurality of pick-up coil windings disposed below the at least one magnetic rotation arm and forming at least one channel, wherein the plurality of wind blades is operable to receive wind to rotate the center shaft and thereby rotate the at least one magnetic rotational arm so that the plurality of magnets rotate within the at least one channel of the array and thereby generate electricity.

These and other features, aspects and advantages of the present invention will become better understood with reference to the following drawings, description and claims.

### BRIEF DESCRIPTION OF THE DRAWINGS

FIG. 1 is a top view of the coil layout of an embodiment of the present invention;

FIG. 2 is a perspective view of the air chamber of an embodiment of the present invention;

FIG. 3 is a schematic view of the center core of an embodiment of the present invention;

FIG. 4 is a schematic view of the air brake of an embodiment of the present invention;

FIG. 5 is a perspective view of the structure of an embodiment of the present invention;

FIG. 6 is a perspective view of the structure of an embodiment of the present invention;

FIG. 7 is a schematic view of the bad weather shroud of an embodiment of the present invention;

FIG. 8 is a top view of the blade assembly of an embodiment of the present invention;

FIG. 9 is a detail perspective view of the structure of an embodiment of the present invention; and

FIG. 10 is a schematic view of the air jet of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a rotating magnetic wind generator. The present invention may be used to supply wind electrical power to high buildings within a city landscape or to any structure that can take advantage of the reduced size of the present invention. The rotating magnetic wind generator has four big advantages: being a circular spinning design to reduce the area needed to support the generator system; being able to supply efficient AC electrical power making its use economical; being able to continue working during high winds and storms; and with only one major moving part it increases the systems reliability of operation.

The present invention is designed to address wind generated alternating current (AC) power usage on all structures of height and would have the ability to supply the AC voltage and currently needed for a wide variety of demands from normal usage to emergency backup operation. The rotating magnetic wind generator is scalable allowing different sizes to be constructed for a wide range of uses and demand loads. Due to the ability to use multiple rotating magnetic wind generators around the same area it is easier to supply a constant current and voltage to large buildings or high demand structures. Adding the magnetic wind generator on all four corners of a building or structure allows for operation without the structure being a factor. The rotating magnetic wind generator employ alarms, rotational wind blade speed monitoring, wind speed and direction monitoring, temperature, voltage, current, phase monitoring and regulation of load voltage and current. The design is flexible and could be varied in a number of ways. The number of wire turns per each coil, reducing the number of magnet arms, the number of magnet sections used to construct each arm magnet assembly, the amount of pickup wire used in the making of the coil, the wire pickup coil combinations arranged in a three phase electrical structure, increasing or reducing the number of wind blades, the lengths of different assemblies incorporated on each blade assembly, and varying the over-all size of the structure while retaining the ratio of the structure assembly parts.

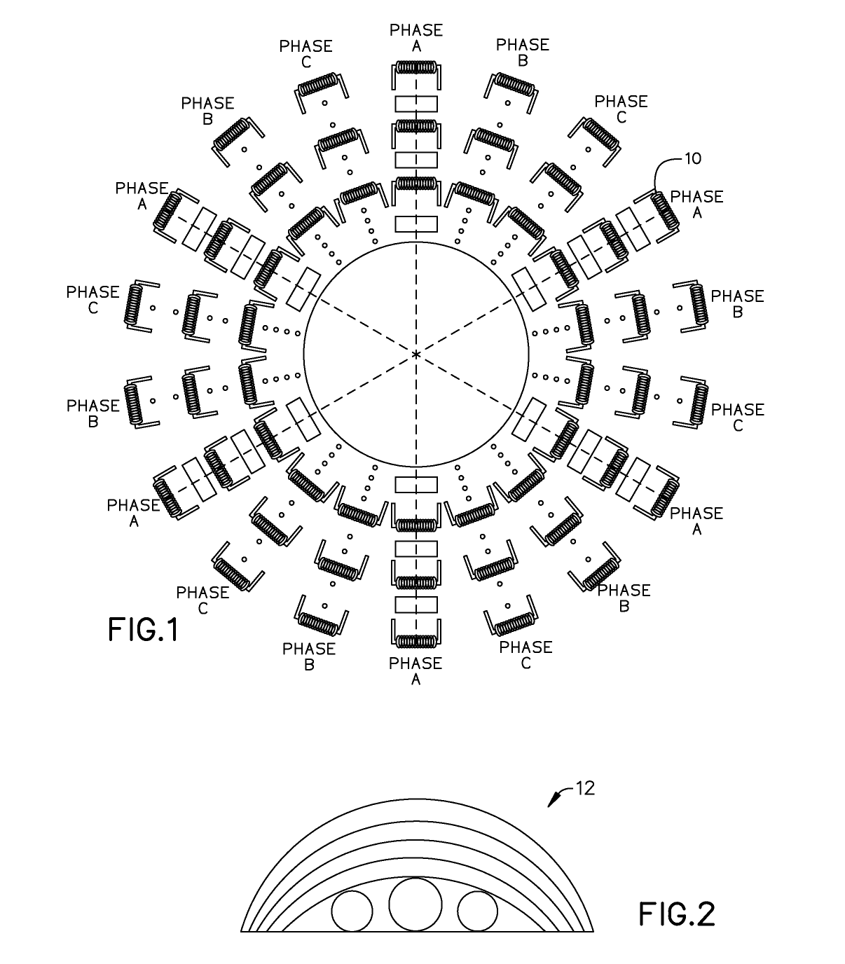

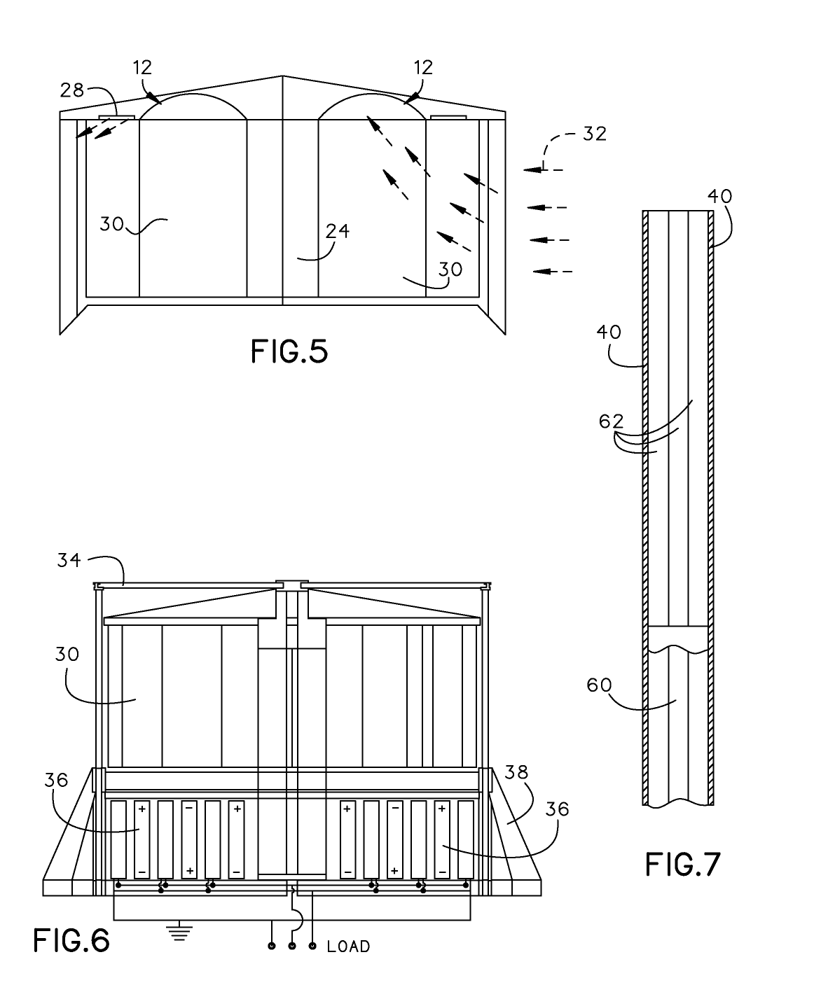

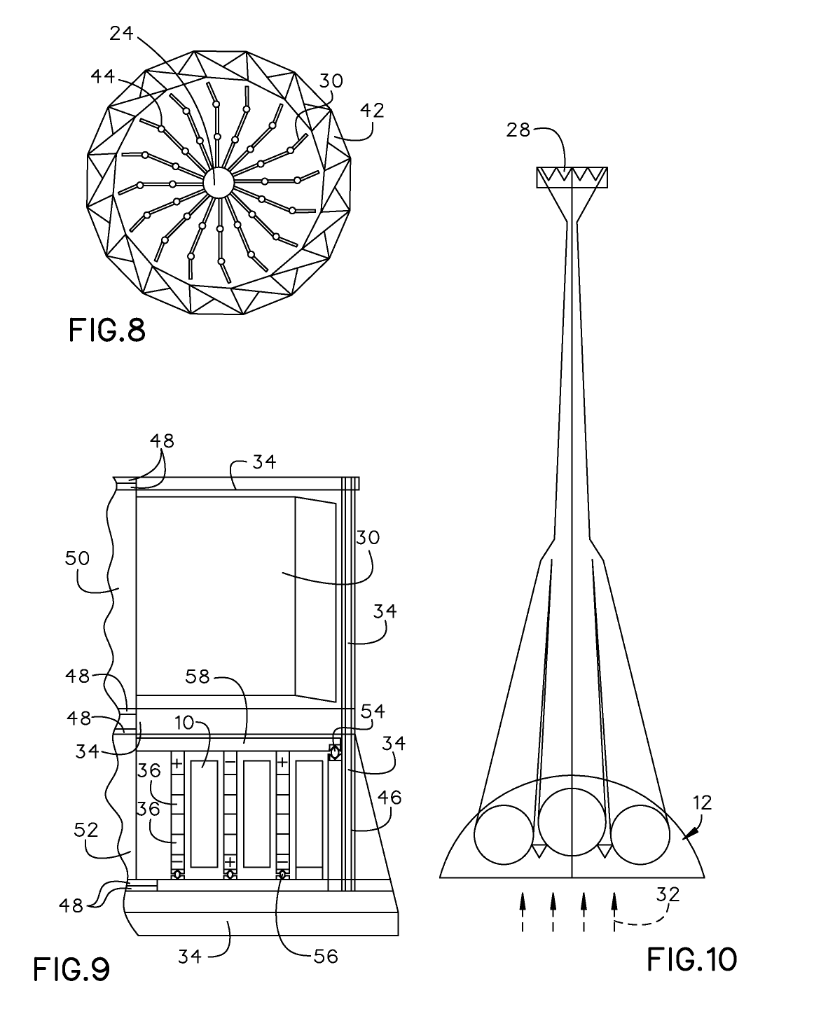

Referring to FIGS. 1 through 10, the present invention includes a wind electrical generator. The wind electrical generator includes a housing 34 having an upper portion 50 and a lower portion 52. A center shaft 24 is rotatably mounted within the housing 34 and runs from the lower portion 52 to the upper portion 50. A plurality of wind blades 30 extend radially from the center shaft 24 at the upper portion 50. The housing 34 directs wind 32 towards the plurality of wind blades 30, striking and being routed into the blade air cavity by an angled frame 38. At least one magnetic rotational arm 58 extends radially from the center shaft 24 at the lower portion 52. A plurality of magnets 36 extend downward from the magnetic rotational arm 58. The present invention further includes an array of pick-up coils 10 forming channels in between. The plurality of wind blades 30 is operable to receive wind 32 to rotate the center shaft 24 and thereby rotate the at least one magnetic rotational arm 58 so that the plurality of magnets 36 rotate within the at least one channel of the array and thereby generate electricity.

The wind blades 30 of the present invention are used to receive wind 32 and thereby rotate the center shaft 24. In certain embodiments, the present invention may include sixteen wind blades 30. However, the present invention is not limited to sixteen wind blades 30 and may utilize a greater or smaller amount of wind blades 30. In certain embodiments, each of the wind blades 30 of the present invention attaches to the central top outside core assembly and uses the wind blade flap 44 as an air deflector. This leading side of each wind blade has a fixed flap 44 extending out from the blade at an angle of 22.5 degrees and is used to catch the wind 32 and direct it into the blade area. The fixed flap 44 helps reduces the air drag as the blade 30 rotates and when it approaches the direction of the wind 32. The joining of the blade 30 and the angled flap 44 may be curved to increase flow inside to the blade area and rounded to reduce drag on the outside wall of the preceding blade 30.

The present invention may include a wind feedback jet system in the upper portion 50 of the housing 34. The floor of the air blade assembly may be grated to allow any deflected air to enter from around the lower base. The present invention may further include air chambers 12 to recalculate the air within the air blade assembly. The inside of each of the wind blade areas is shaped to allow the air to be directed upward into the air chamber 12. Air entering the chamber 12 may then be directed to the opposite leeward side of the wind generator blade assembly through pipes to exit as a jet air stream. This is completed by allowing chamber 12 to accept exiting wind 32 from the wind blade 30 and routing it into the air jet collection chamber. Then the air is moved through three pipes combining and increasing in speed into one pipe routing the wind 32 to the opposite side of the wind blade assembly to exit as a small jet 28 adding additional rotational push force on the leeward side of the wind generator.

The present invention may incorporate fail safes for inclement weather, and high speed winds. The first is a plurality of channels 22 each containing four sliding windows 20 located on the wind blade 30 just before the angled flap 44. As the wind blade assembly rotates faster the windows pull against the precise springs 64 holding the windows 20 closed and opens each window 20, one at a time, dumping the incoming air and reducing the pushing force on the wind blades 30, thereby slowing the rotation. Each window 20 may include a different strength set of precise springs 64 allowing greater rotational speed control. The second is the storm shroud 40 that may be raised during a storm using a hydraulic piston 60 or other actuator from a storage shroud 46 at the lower portion of the housing 34. The shroud 40 may include angled slits cut vertically through the housing 62 to allow a small wind force to enter the wind blade assembly. The angled slits allow the air pushing through the openings to push against the wind blade assembly at an angle and in the direction of rotation. This allows the generator to continue to produce power during the storm with the storm shroud 40 partially or fully extended.

The present invention includes a magnetic portion in the lower portion 52 of the housing 34. As illustrated FIG. 1, the present invention includes an array of fixed electrical pickup coils 10. In certain embodiments, the array may include three rings of eighteen pick-up coils 10, totaling fifty four coils 10. Each ring forms a channel in between. The magnets 36 may travel within the channels. Each coil pickup ring is arranged in a three-phase “Y” with a grounded neutral configuration and all three rings are connected together in-order to generate reliable AC power. All fifty four magnetic pickup coils 10 are thus configured forming three legs of an electrical “Y” circuit including phase A, B, and C.

In certain embodiments, the present invention includes at least one magnetic rotational arm 58. The present invention may include six magnetic rotational arms 58 spaced evenly around the center shaft 24. Each of the magnetic rotational arms 58 may include three fixed magnets 36 attached, revolving in three tracks between three fixed rings of magnetic pickup wire coils 10. The three rings of magnets 36 rotate in-between the three rings of pickup coils 10 generating AC voltage. In certain embodiments, the magnets 36 may fit in a four door frame located in each magnet panel. Smaller magnets are assembled into larger ones by sliding them into a frame, locking them into the frame and assembling the four frames together. Each of the magnetic door frames may swing 90% out of the magnetic force field, opening and closing, to lock the smaller magnet frame into a larger arm support frame.

The center shaft 24 is rotated by the wind blades 30, thereby rotating the magnetic rotational arms 58. The center shaft 24 may be set within bearing rings 48 set within the housing 34 to help in stabilizing the rotation of the center shaft 34. In certain embodiments, seven sets of bearings 48 will be used in the housing 34 of the magnetic wind generator. Two sets may be placed in the base, two sets may be in the lower center between the air blade assembly and the magnet generator assembly, two sets at the top and one set at the very top holding the central shaft 34 to the top of the housing 34. The bearing sets aid in the rotation of the central shaft 34 and aid in stabilizing the spinning action.

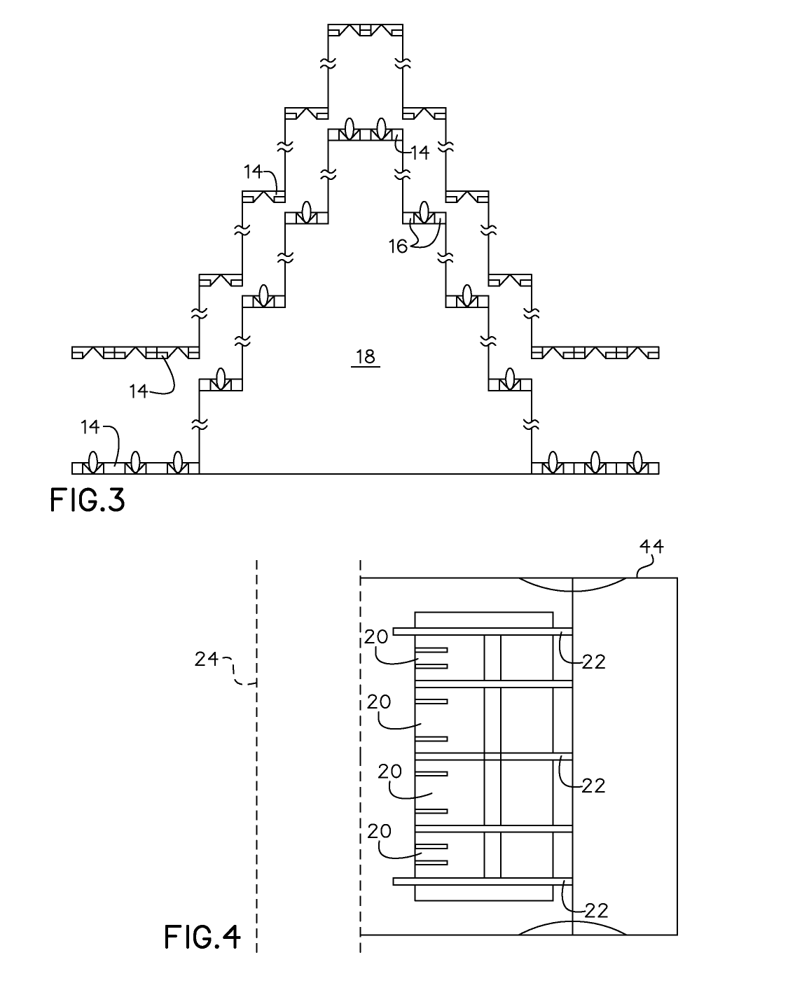

As illustrated in FIG. 3, the center shaft 24 may be divided into two parts to reduce the weight of the rotating portion. The base 18 is fixed and is part of the bottom housing 34. The top outer central core sets over the inside base 18 mounted central core and is free spinning with the wind blades 30 and the magnet support arms 58 attached to it. The inside stepped construction between the outer and inner central cores reduces the total weight of the shaft 24 and improves balance. In certain embodiments, reverse natural and manmade magnets 14, 16 are used in a stepped configuration inside the center core, on the bottom of each magnet panel and in a support track along the inside of the outer lower frame to aid in the magnetic arm weight support and rotation. The reverse magnets 14, 16 may include magnets with like poles facing towards one another, providing additional lift. Small wheels 54, 56 may be used in tracks between the reverse magnet strips to add support and guidance. The reverse magnets 14, 16 used around each step generate lift and the wheels 54, 56 are used for lift and guidance.

The housing 34 of the present invention may be made with stainless steel materials which increases the overall strength of the generator. It helps during construction and operation due to its non-magnetic properties. In certain embodiments, the housing 34 may include four foot lightning rods standing vertical from each of the sixteen vertical frame support columns. Attached to the each lightning rod is a number two copper cable. The connecting cables run down the vertical columns and connect (in groups of four) to four small lightning bus bars located around the bottom of the lower assembly. A 340 degree semi-circle number two copper cable connects all the lightning bars into one lower main lightning bus bar. A main ground run using number “00” copper cable may run from the lightning common bus bar to the electrical ground rod in the main electrical basement room or another approved electrical code grounding point. A common grounding bus bar may be mounted above the base lightning semi-grounding cable ring and will have all internal grounds connected to it. There may be one number “0” copper cable connecting the internal grounding bus bar to the number “00” main grounding cable going toward the basement of grounding system.

A method of using the present invention to generate electricity may include the following. Moving air strikes the circular wind blades using the 22½ degree flap as a deflector pushing air into the air blade cavity. The air strikes the main body of the blade causing the assembly to rotate. Reversing the direction of the flaps and wind blade assembly changes the rotational direction of the wind generator assembly. (Note: if the air is causing the rotation to become too fast the air brake flap, located on the main part of the blade assembly, will slide open dumping some of the air's pushing force). The air from around the base of the magnetic wind generator is vectored upward around the base to enter the bottom of each wind blade cavity for added force and to help push the air upward. The air is pushed out of the air blade cavity upward into the air chamber located above each air wind blade assembly. The air in the air chamber exits through an air combining pipe system forming one air stream. The air stream is piped to the opposite side of the wind generator along the upper frame of the wind blade and exits the piping as an air jet aiding the spinning rotational force.

The passive air jet feed-back routing system on top of each wind blade area collects wind moving upward from the air blade chamber and routes the air into the back of the top air jet collection chamber. At the end of the air chamber the moving air enters a three-pipe-assembly equally. The center pipe proceeds toward the opposite side without a size reduction. The two outside pipes do reduce in size and re-enter the center pipe with a speeded up air flow helping to move the air in the center pipe faster. After the two outside pipes have entered the center pipe, the center pipe starts to reduce in size until exiting from a jet constructed opening along the top of each of the wind blade's flap assemble opposite the entry blade. The jet is located on the opposite side of the wind generator, from where the air had entered, along the top of the wind blade flap and is aiding in rotational force by giving a small push on each wind blade cavity as the wind enters on the opposite side. Using spinning magnets to generate the voltage and current instead of moving the wire coils allows generated power to tie directly to the load without any mechanical coupling thus reducing the moving parts and allowing for less operational failures. The magnetic wire pickup coils can be produced using as large a coil as is physically possible within the lower generator's area space because the coils are fixed to the lower assembly, they may not move and weight is not a concern in their design. The use of wind routing on the outside of the structure and the wind jet feed-back system for the leeward side of the wind blade assembly help add to the winds generating power and efficiency. The use of stainless steel for the magnetic wind generator assembly adds strength and does not react with the magnetic fields being produced. The top of the air blade cavities and feedback air jet assemblies are covered by an inclined roof housing aiding in the aerodynamics of the structure. The roof housing covers the wind collection chamber and piping used for the feedback jets. The housing revolves and is attached to the top center core.

All rotational force developed from the air blade and air feedback system is used to spin the top outside center core that channels the rotational force to the six support arms holding eighteen magnets (assembled in three rings of six forming the magnetic rings spaced within the lower magnetic body) also attached to the top outer center core. The magnets in each ring have the same north/south pole orientation. The middle magnet ring will reverse the north/south pole orientation in some test models to take advantage of the added flux between rings at the top and bottom of the magnets. The magnets revolve between coils of magnetic pickup wire and form the generator assembly. The rotating magnets pass in-between rings of the fifty-four fixed stationary pickup wire coils (assembled in three rings of eighteen coils in each ring) generating the AC voltage. By using six arms the magnets will be spaced evenly around each magnetic ring and will all pass by eighteen of the fifty-four magnetic pickup coils at the same time. This allows all eighteen coils to be connected together making one phase of the three-phase AC system. As the six arms rotate to the next set of eighteen magnetic pickup coils another phase is generated. This action continues through the third phase and then repeats on a steady basis. The eighteen pickup wire coils in each wire ring will be open air coils for fast magnetic switching and each of the coils width around the ring will be slightly larger than the width of the magnet panels. All fifty-four magnetic pickup wire coils wired in a three-phase configuration produce the electrical voltage to feed an electrical “Y” configuration with a grounded neutral for the output transformer coupled to the load.

A method of making the present invention may include the following. The assembly of the generator would be done using three large wooden platforms setting in a field far from power lines, RF communications sites and metal structures. The first wooden platform would be the assembly area for the frame, wind blade assemblies and all air routing assemblies. When the frame is complete other assemblies would be added to it on this platform to complete the magnetic wind generator. All wire pickup coils would be mounted to the base frame rings and connected on this platform. The platform's shape will match the magnet wind generator and aid in allowing access for the tractor to assemble different parts into the finished assembly. The second wooden platform would be an assembly area for assembling magnet panels forming the lower magnet revolving rings. The revolving magnet support arm and upper central core are assembled here. The placing of the magnets into the magnet frame attached to the revolving arms is completed on number two platform. The third wooden platform would be a holding area for the magnets themselves. The combining of magnets into larger magnet panels is preformed on this platform. The three platforms must be separated by some distance to prevent interaction from the magnets on the three platforms and to allow movement of assemblies between platforms. A non-magnetic tracker with a long non-magnetic attachment arm would be used to move the magnets from the holding area platform to the lower assembly platform. The tractor arm would slip the magnets into each frame holder attached to the revolving magnet arm. The same tractor would be used in lowering the upper rotating wind blade assembly and the lower revolving magnetic assembly onto the base central core, being part of the base.

The design of the horizontal rotating wind blade assembly reduces the area needed for the structure and opens up a wide number of different usages where the advantage of wind generated AC power could be applied. The use of passive wind routing on the outside of the structure to move wind into the air blade cavity and the wind feed-back jet system in the top of the structure pushing wind force to the leeward side of the air blade assembly adds to the efficiency of the wind generating system. The location of the magnets, the weight of the magnetic pickup wire in the bottom of the structure, the magnet wind generator assemblies weight and the horizontally spinning of those magnets within the pickup coil rings helps secure and balance the wind generator while on the building.

The wind generator design would work on any building or structure having height, air movement and meeting the structural weight requirements. The space that is needed is limited to the diameter of the generator plus interface electrical transformers. The placement can take advantage of wind coming from any direction and will not affect the systems AC voltage output. The magnet wind generator would work in any weather condition and failures would be low due to one main moving part.

It should be understood, of course, that the foregoing relates to exemplary embodiments of the invention and that modifications may be made without departing from the spirit and scope of the invention as set forth in the following claims.

What is claimed is:

1. A wind electrical generator comprising:
a housing comprising an upper portion and a lower portion;
a center shaft rotatably mounted within the housing and running from the lower portion to the upper portion;
a plurality of wind blades extending radially from the center shaft at the upper portion, wherein the housing directs wind towards the plurality of wind blades;
at least one magnetic rotational arm extending radially from the center shaft at the lower portion;
a plurality of magnets extending downward from the at least one magnetic rotational arm;
an array of a plurality of pick-up coils disposed below the at least one magnetic rotation arm and forming at least one channel,
wherein the plurality of wind blades is operable to receive wind to rotate the center shaft and thereby rotate the at least one magnetic rotational arm so that the plurality of magnets rotate within the at least one channel of the array and thereby generate electricity.

2. The wind electrical generator of claim 1, wherein the plurality of wind blades comprises sixteen wind blades.

3. The wind electrical generator of claim 1, wherein each of the plurality of wind blades comprises a deflector flap at an end, wherein the deflector flap is angled relative to the wind blade.

4. The wind electrical generator of claim 3, wherein the deflector flap is at a 22.5 degree angle relative to the wind blade.

5. The wind electrical generator of claim 1, further comprising a feedback jet system within the upper portion of the housing, wherein the feedback jet system comprises an air chamber to receive wind and a jet to deliver wind to the plurality of wind blades on an opposite side of the air chamber.

6. The wind electrical generator of claim 1, wherein at least a portion of the plurality of wind blades comprise at least one spring biased sliding window, wherein the spring biased sliding window opens once a threshold of wind speed is reached.

7. The wind electrical generator of claim 1, further comprising a storm shroud operable to extend and surround at least a portion of the housing once a threshold of wind speed is reached.

8. The wind electrical generator of claim 7, wherein the storm shroud comprises angled slots therethrough.

9. The wind electrical generator of claim 1, wherein the array forms a three phase Y electrical structure.

10. The wind electrical generator of claim 9, wherein the array comprises three rings of eighteen pick up coils, wherein the channels are formed in between the three rings.

11. The wind electrical generator of claim 1, wherein the at least one magnetic rotational arm is six magnetic rotational arms spaced evenly around the center shaft.

12. The wind electrical generator of claim 12, wherein each of the six magnetic rotational arms comprise three fixed magnets.

13. The wind electrical generator of claim 1, wherein the center shaft is attached to the housing by a plurality of bearing rings.

14. The wind electrical generator of claim 1, wherein the center shaft comprises a base portion and a rotational portion, wherein the base portion is fixed and the rotational portion rotates about the base portion via wind rotating the wind blades.
